(19) United States
(12) Patent Application Publication
(10) Pub. No.: US 2023/0182468 A1
(43) Pub. Date: Jun. 15, 2023

(54) HEAD UNIT AND INK-JET RECORDING APPARATUS

(71) Applicant: KYOCERA Document Solutions Inc., Osaka (JP)

(72) Inventor: Tomohiro SUE, Osaka (JP)

(73) Assignee: KYOCERA Document Solutions Inc., Osaka (JP)

(21) Appl. No.: 17/926,447

(22) PCT Filed: Feb. 10, 2022
(86) PCT No.: PCT/JP2022/005275

§ 371 Date: Nov. 18, 2022

(30) Foreign Application Priority Data
Feb. 22, 2021 (JP) 2021-026659

(51) Int. Cl. B41J 2/14; B41J 25/00

(52) U.S. Cl. CPC B41J 2/1433; B41J 25/003

(57) ABSTRACT

A head unit (51) includes a recording head (52), a frame (53), and an angle adjusting portion (8). The frame (53), to which the recording head (52) is rotatably connected, has a side wall (531) to be adjacent to the recording head (52). The angle adjusting portion (8) includes frame and head adjusting screws (81, 82) and rotates the recording head (52). The frame adjusting screw (81) is on the side wall (531), on its face opposite the recording head (52), and can reciprocate toward and away from the recording head (52). The head adjusting screw (82) is on the recording head (52), on its face opposite the side wall (531), and can reciprocate toward and away from the side wall (531). The frame and head adjusting screws (81, 82) make contact with each other at their tip end parts in the direction in which they face each other.

### TECHNICAL FIELD

The present invention relates to a head unit and to an ink-jet recording apparatus.

### BACKGROUND ART

A head unit incorporated in an ink-jet recording apparatus includes a recording head having a plurality of nozzles for ejecting ink on a recording medium such as a sheet, and records an image on the recording medium. One example of such head units is disclosed in Patent Document 1 identified below.

Patent Document 1 discloses a known ink jet recording apparatus that includes a head assembly (head unit) having three recording heads. The recording heads are coupled to a base member of the head assembly with a coupling member.

### LIST OF CITATIONS

### Patent Literature

Patent Document 1: Japanese Patent Application published as No. 2020-121514.

### SUMMARY OF THE INVENTION

### Problem to be Solved by the invention

With the known technology, if, when a user is using the ink-jet recording apparatus, a fault or the like occurs that requires replacement of a recording head, it is difficult to replace the recording head alone and, inconveniently, the whole head assembly needs to be replaced. Thus, it is necessary to replace also another component unnecessarily, and there is thus concern for increased cost. Also, even if the recording head alone can be replaced, it is not possible for a user to align the new recording head with respect to the existing base member.

In view of the situation described above, an object of the present invention is to provide a head unit and an ink-jet recording apparatus that allows easy replacement of a recording head as well as cost reduction.

### Means for Solving the Problem

To achieve the above object, a head unit according to the present invention includes a recording head, a frame, and an angle adjusting portion. The recording head has a plurality of nozzles for ejecting ink on a recording medium. The frame has a side wall that extends in a width direction perpendicular to a conveying direction of the recording medium to be adjacent to the recording head. To the frame, the recording head is connected rotatably about a head rotary shaft arranged in an end part of the recording head in the width direction. The angle adjusting portion is arranged at an other end part side of the recording head, opposite from the head rotary shaft in the width direction, and rotates the recording head about the head rotary shaft. The angle adjusting portion includes a frame adjusting screw and a head adjusting screw The frame adjusting screw is provided on the side wall, on its face opposite the recording head. The frame adjusting screw can reciprocate in directions toward and away from the recording head. The head adjusting screw is provided on the recording head, on its face opposite the side wall. The head adjusting screw can reciprocate in directions toward and away from the side wall. The frame adjusting screw and the head adjusting screw make contact with each other at their tip end parts in the direction in which they face each other.

### Advantageous Effects of the Invention

With this construction, during the assembly of the head unit, after the head adjusting screw is adjusted in the recording head, the recording head is fitted to the frame, and the frame adjusting screw is adjusted in the frame. This allows easy replacement of the recording head alone. There is also no need to replace any other components unnecessarily, and this permits cost reduction. Furthermore, when the recording head is replaced, a new recording head is fitted to the frame that has the frame adjusting screw already adjusted; thus, a user can easily adjust alignment.

### BRIEF DESCRIPTION OF DRAWINGS

FIG. 1 is a schematic sectional front view of an ink-jet recording apparatus according to one embodiment of the present invention;

FIG. 2 is a plan view of a recording portion in the ink jet recording apparatus 1 in FIG. 1;

FIG. 3 is a horizontal sectional view of a head unit in the recording portion in FIG. 2;

FIG. 4 is a part horizontal sectional view of and around an angle adjusting portion in the head unit in FIG. 3;

FIG. 5 is a perspective view of a side wall of the head unit in FIG. 3;

FIG. 6 is a perspective view of a recording head in the head unit in FIG. 3; and

FIG. 7 is a part perspective view of and around the angle adjusting portion in the recording head in FIG. 6.

### DESCRIPTION OF EMBODIMENTS

An embodiment of the present invention will be described below with reference to the accompanying drawings. The present invention is, however, not limited to what is specifically described below.

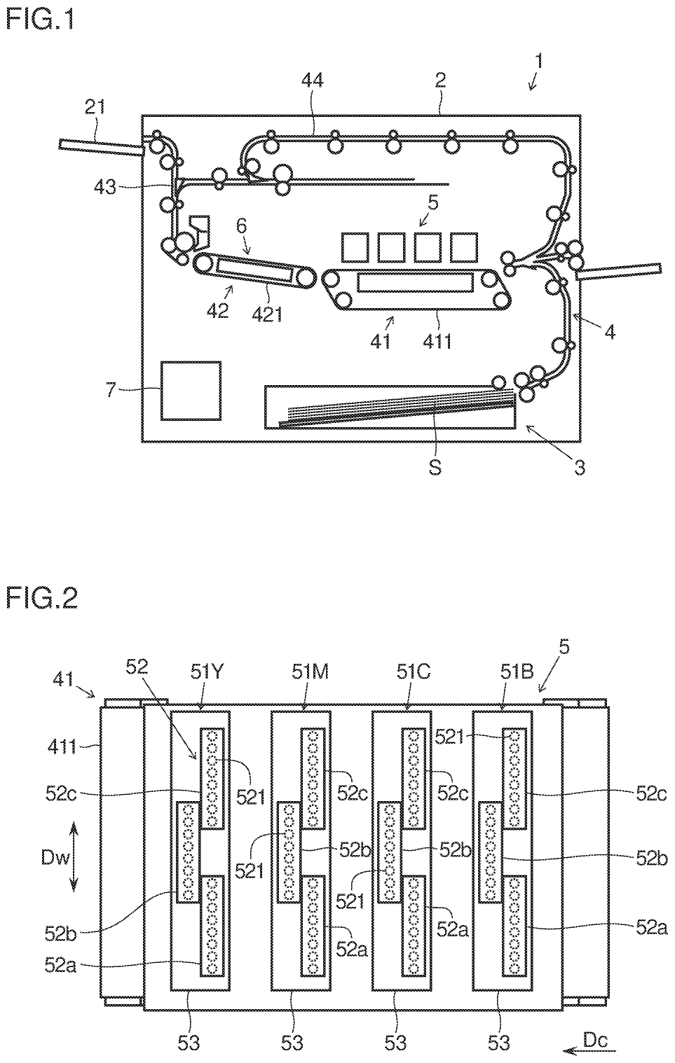

FIG. 1 is a schematic sectional view of an ink-jet recording apparatus 1 according to an embodiment. FIG. 2 is a plan view of a recording portion 5 in the ink-jet recording apparatus 1 in FIG. 1. The ink-jet recording apparatus 1 is, for example, a printer of an ink-jet recording type. The ink-jet recording apparatus 1 includes, as shown in FIGS. 1 and 2, an apparatus main body 2, a sheet feeding portion 3, a sheet conveying portion 4, a recording portion 5, a drying portion 6, and a control portion 7.

The sheet feeding portion 3 stores a plurality of sheets (of a recording medium) S and, during recording, feeds them out one after another separately. The sheet conveying portion 4 conveys a sheet S fed out from the sheet feeding portion 3 to the recording portion 5 and then to the drying portion 6, and then discharges the sheet S after recording and drying to a sheet discharge portion 21. When duplex recording is performed, the sheet conveying portion 4 switches, with a branch portion 43, the conveying direction of the sheet S after recording on its first side and drying to a reversing conveying portion 44, and conveys the sheet S having its conveying direction switched and its obverse and reverse sides reversed to the recording portion 5 and then to the drying portion 6 once again.

The sheet conveying portion 4 includes first and second belt conveying portions 41 and 42. The first belt conveying portion 41 has a first conveying belt 411 formed so as to be endless. The second belt conveying portion 42 has a second conveying belt 421 formed so as to be endless. The first and second first belt conveying portions 41 and 42 convey a sheet S by holding it by suction on their upper outer faces (top faces). The first belt conveying portion 41 is arranged under the recording portion 5 and conveys the sheet S. The second belt conveying portion 42 is arranged downstream of the first belt conveying portion 41 in the sheet conveying direction in the drying portion 6 and conveys the sheet S.

The recording portion 5 faces the sheet S that is conveyed while being held by suction on the top face of the first conveying belt 411 and is arranged above the first conveying belt 411 across a predetermined gap from it. As shown in FIG. 2, the recording portion 5 includes head units 51B, 51C, 51M, and 51Y corresponding to four colors, namely black, cyan, magenta, and yellow. The head units 51B, 51C, 51M, and 51Y are arranged side by side along the sheet conveying direction Dc such that their longitudinal direction is parallel to the sheet width direction Dw perpendicular to the sheet conveying direction Dc. The four head units 51B, 51C, 51M, and 51Y have basically similar structures. Thus, in the following description, the suffixes “B”, “C”, “M”, and “Y” distinguishing different colors are often omitted, unless distinction is needed.

The head units Si for the different colors each include line recording heads 52 of an ink-jet type. In each of the head units 51 for the different colors, a plurality of recording heads 52 (for example, three of them (52a, 52b, and 52c)) are arranged in a staggered formation along the sheet width direction Dw.

The recording head 52 has a plurality of ink ejecting nozzles 521 in a bottom part of it. The plurality of ink ejecting nozzles 521 are arrayed along the sheet width direction Dw so that ink can be ejected over the entire recording region of the sheet S. That is, the recording head 52 has a plurality of ink ejecting nozzles 521 for ejecting ink on the sheet S. The recording portion 5 ejects ink sequentially from the recording heads 52 in the head units 51B, 51C, 51M, and 51Y of four colors toward the sheet S conveyed by the first conveying belt 411 so as to record on it a full-color image or a monochrome image.

The drying portion 6 is arranged downstream of the recording portion 5 in the sheet conveying direction and includes the second belt conveying portion 42. While the sheet S with an ink image recorded on it in the recording portion 5 is being conveyed while being held by suction on the second conveying belt 421 in the drying portion 6, the ink is dried.

The control portion 7 includes a CPU, a storage portion, and other electronic circuits and components (none of which are illustrated). The CPU, based on control programs and data stored in the storage portion, controls the operation of different components provided in the ink-jet recording apparatus 1 to perform processing related to the functions of the ink-jet recording apparatus 1. The sheet feeding portion 3, the sheet conveying portion 4, the recording portion 5, and the drying portion 6 individually receive commands from the control portion 7 and coordinate to perform printing on the sheet S. The storage portion is composed of, for example, a combination of an unillustrated non-volatile storage device, such as a program ROM (read-only memory) and a data ROM, and an unillustrated volatile storage device, such as a RAM (random-access memory).

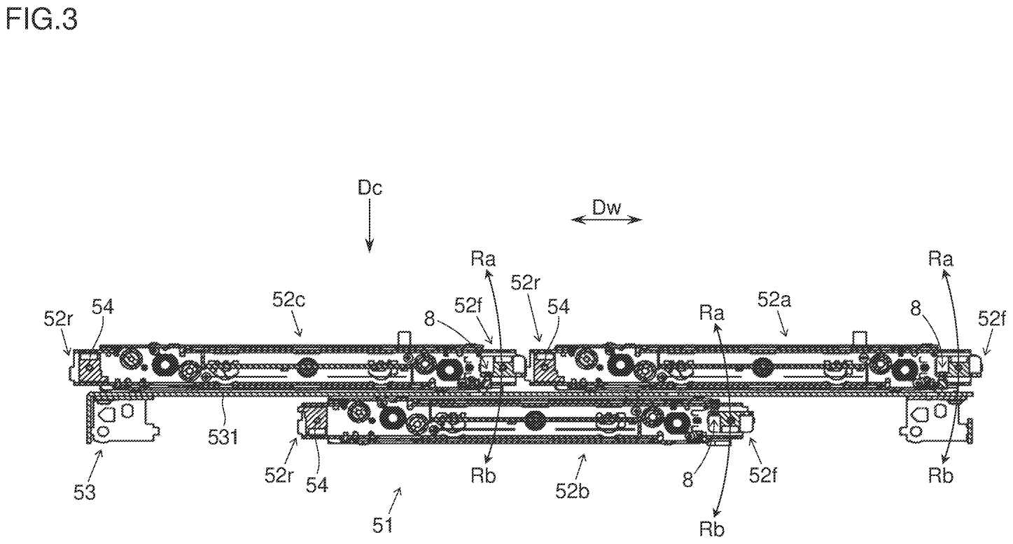

Next, the construction of the head unit 51 in the ink-jet recording apparatus 1 will be described with reference to FIG. 3 as well as FIG. 2. FIG. 3 is a horizontal sectional view of the head unit 51 in the recording portion 5 in FIG. 2.

The head unit 51 includes, in addition to the recording head 52, a frame 53, a head rotary shaft 54, and an angle adjusting portion 8.

The frame 53 holds three recording heads 52a, 52b, and 52c. The three recording heads 52a, 52b, and 52c are arranged in a staggered formation along the sheet width direction Dw. The frame 53 has a side wall 531. The side wall 531 extends in the up-down direction and in the sheet width direction Dw to make contact with the recording heads 52a, 52b, and 52c. The side wall 531 is arranged between two recording heads 52a and 52c and one recording head 52b in the sheet conveying direction Dc. The side wall 531 faces the side faces of the recording heads 52 on the downstream or upstream side in the sheet conveying direction Dc.

The head rotary shaft 54 is one end part 52r of each recording head 52 in the longitudinal direction (sheet width direction Dw) and is arranged, for example, in an end part of the recording head 52 at the rear side of the recording portion 5. The rotation axis of the head rotary shaft 54 extends in the up-down direction, which is the direction normal to the top face of the first conveying belt 411.

The three recording heads 52 are each connected to the frame 53 so as to be rotatable about the head rotary shaft 54. The recording head 52 is rotatable in a rotation direction Ra in which an other end part 52f side of it in the longitudinal direction (sheet width direction Dw) moves upstream in the sheet conveying direction Dc about the head rotary shaft 54, or in a rotation direction Rb in which the other end part 52f moves downstream in the sheet conveying direction Dc about the head rotary shaft 54.

The angle adjusting portion 8 is arranged at the other end part 52f side of the recording head 52, opposite from the head rotary shaft 54, for example, in an end part of the recording head 52 at the front side of the recording portion 5. The angle adjusting portion 8 rotates the recording head 52 about the head rotary shaft 54 in the rotation direction Ra or Rb. In this way, the angle adjusting portion 8 can adjust the angle of the recording head 52 with respect to the frame 53 of the head unit 51, thus, it is possible to position the recording head 52 properly with respect to the head unit 51.

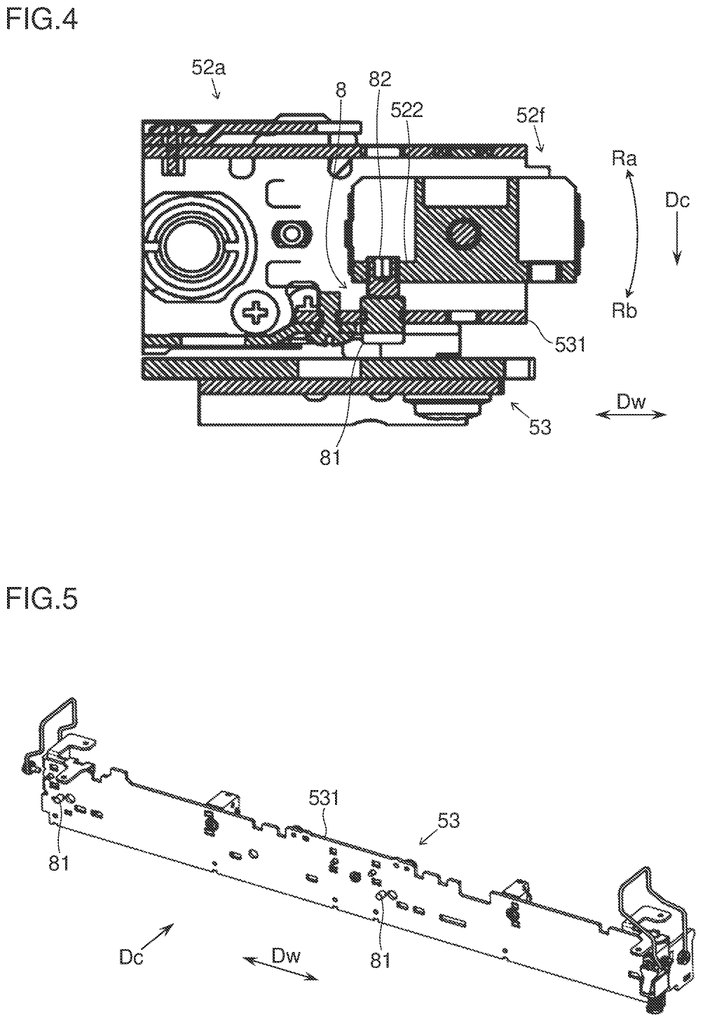

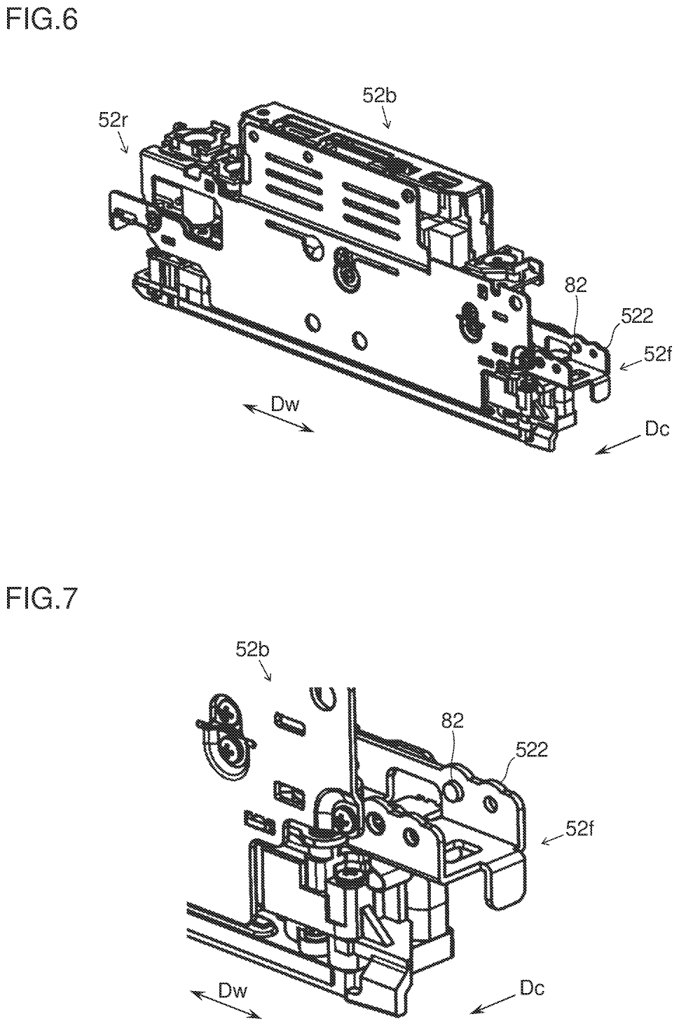

Next, the structure of the angle adjusting portion 8 will be described with reference to FIGS. 4 to 7 as well as FIG. 3. FIG. 4 is a part horizontal sectional view of and around the angle adjusting portion 8 in the head unit 51 in FIG. 3. FIG. 5 is a perspective view of the side wall 531 of the head unit 51 in FIG. 3. FIG. 6 is a perspective view of the recording head 52 in the head unit 51 in FIG. 3. FIG. 7 is a part perspective view of and around the angle adjusting portion 8 in the recording head 52 in FIG. 6.

The angle adjusting portion 8 includes a frame adjusting screw 81 and a head adjusting screw 82.

The frame adjusting screw 81 is provided on the side wall 531, on its face opposite the recording head 52. The frame adjusting screw 81 is fitted perpendicularly to the side wall 531 so as to penetrate the side wall 531, and extends in a direction intersecting with the rotation axis of the head rotary shaft 54 (i.e., in the sheet conveying direction Dc). The frame adjusting screw 81 is, for example, a setscrew having a hexagonal hole or a slot formed in an end part of it. The frame adjusting screw 81 can reciprocate in directions toward and away from the recording head 52.

The head adjusting screw 82 is provided on the recording head 52, on its face opposite the side wall 531. The head adjusting screw 82 is fitted perpendicularly to a side plate 522 of the recording head 52 so as to penetrate the side plate 522, and extends in a direction intersecting with the rotation axis of the head rotary shaft 54 (i.e., in the sheet conveying direction Dc). The head adjusting screw 82 is, for example, a setscrew having a hexagonal hole and a slot formed in an end part of it. The head adjusting screw 82 can reciprocate in directions toward and away from the side wall 531.

The frame adjusting screw 81 and the head adjusting screw 82 are arranged at positions at which they face each other in a direction intersecting with the rotation axis of the head rotary shaft 54 (i.e., in the sheet conveying direction Dc). That is, the frame adjusting screw 81 and the head adjusting screw 82 are arranged at positions at which they face each other in the longitudinal direction (sheet width direction Dw) of the head unit 51 and in the up-down direction, and their extending directions (moving directions) are the same. The frame adjusting screw 81 and the head adjusting screw 82 make contact with each other at tip end parts of them in the direction in which they face each other.

With this construction, during the assembly of the head unit 51, after the head adjusting screw 82 is adjusted in the recording head 52, the recording head 52 is fitted to the frame 53, and the frame adjusting screw 81 is adjusted in the frame 53. This allows easy replacement of the recording head 52 alone, There is also no need to replace any other components unnecessarily, and this permits cost reduction. Furthermore, when the recording head 52 is replaced, a new recording head 52 is fitted to the frame 53 that has the frame adjusting screw 81 already adjusted; thus, a user can easily adjust alignment.

The head unit 51 includes a plurality of (three in this embodiment) recording heads 52 that are arranged side by side in the sheet width direction Dw. With this construction, when, for example, one recording head 52 needs to be replaced, the other two recording heads 52 can continue to be used without necessity of replacement. Thus, it is possible to reduce the cost of the head unit 51.

The three recording heads 52a, 52b, and 52c are, as described above, arranged in a staggered formation along the sheet width direction Dw (see FIG. 3), Two recording heads 52a and 52c are arranged upstream of the side wall 531 in the sheet conveying direction Dc, and one recording head 52b is arranged downstream of the side wall 531 in the sheet conveying direction Dc. That is, a plurality of recording heads 52 are arranged both upstream and downstream of the side wall 531 in the sheet conveying direction Dc.

With the above construction, for example, it is possible to provide the angle adjusting portion 8 using the frame adjusting screw 81 and the head adjusting screw 82 to each of the three recording heads 52a, 52b, and 52c arranged in a staggered formation along the sheet width direction Dw. That is, even when the recording heads 52 are arranged side by side in the sheet conveying direction Dc, it is possible to replace the recording head 52 alone easily.

The ink-jet recording apparatus 1 includes the head unit 51 constructed as described above which records an image on the sheet S. With this construction, it is possible to provide an ink-jet recording apparatus 1 that has a low-cost construction and that allows easy replacement of a recording head 52.

The description given above of an embodiment of the present invention is in no way meant to limit the scope of the present invention; the present invention can be implemented with any modifications made without departing from the spirit of the present invention.

### Industrial Applicability

The present invention is applicable to head units and inkjet recording apparatuses.

1. Ahead unit comprising:
a recording head including a plurality of nozzles for ejecting ink on a recording medium;
a frame
which has a side wall that extends in a width direction perpendicular to a conveying direction of the recording medium to be adjacent to the recording head and
to which the recording head is connected rotatably about a head rotary shaft arranged in an end part of the recording head in the width direction; and
an angle adjusting portion
which is arranged at another end part side of the recording head, opposite from the head rotary shaft in the width direction, and
which rotates the recording head about the head rotary shaft,
wherein
the angle adjusting portion includes:
a frame adjusting screw
which is provided on the side wall, on a face thereof opposite the recording head and
which can reciprocate in directions moving toward and away from the recording head; and
a head adjusting screw
which is provided on the recording head, on a face thereof opposite the side wall and
which can reciprocate in directions moving toward and away from the side wall, and
the frame adjusting screw and the head adjusting screw make contact with each other at tip end parts thereof in a direction in which the frame adjusting screw and the head adjusting screw face each other.

2. The head unit according to claim 1, further comprising a plurality of the recording heads arranged side by side in the width direction of the recording medium.

3. The head unit according to claim 2,
wherein
the plurality of recording heads are arranged both upstream and downstream of the side wall in the conveying direction of the recording medium.

4. An inkjet recording apparatus comprising the head unit according to claim 1.
